(19) United States
(12) Patent Application Publication
(10) Pub. No.: US 2002/0097891 A1
(43) Pub. Date: Jul. 25, 2002

(54) Electronic watermarking data insertion/detection device

(75) Inventor: Satomi Hinishi, Tokyo (JP)

Correspondence Address: SCULLY, SCOTT, MURPHY & PRESSER, 400 Garden City Plaza, Garden City, NY, 11530, US

(73) Assignee: NEC Corporation, Tokyo (JP)

(21) Appl. No.: 10/013,261

(22) Filed: Dec. 7, 2001

(30) Foreign Application Priority Data
Dec. 7, 2000 (JP) 372312/2000

(51) Int. Cl. G06K 9/00

(52) U.S. Cl. 382/100

(57) ABSTRACT

An electronic watermarking data insertion/detection device inserts plural kinds of electronic watermarking data in a block by entering digital images as image data, converting the entered image data into frequency components with the DCT or the like for each block of pixels, fetching the converted frequency components (DCT coefficients), and inserting the fetched DCT coefficients into electronic watermarking data according to contents of an electronic watermarking data insertion DCT coefficient table. Further, the device detects the inserted electronic watermarking data by calculating a degree of a similarity between extracted electronic watermarking data and electronic watermarking data corresponding to an ID number shown by the electronic watermarking data extraction DCT coefficient designation table.

### BACKGROUND OF THE INVENTION

1. Field of the Invention

The invention relates to an electronic watermarking data insertion/detection device and, in particular, to an electronic watermarking data insertion/detection device which is capable of preventing illegal reproduction (copy) of image data.

2. Description of the Related Art

In several years, there is a problem that digitized images (hereinafter, which are simply referred to as “images” or “digital images”) are reproduced illegally. Such the digital images have a characteristic that a quality of the digital images is not degraded even if the reproduction of the digital images is performed many times, since the digital images include only two identification codes zero and one. Because of the characteristic, once the digital images are reproduced, an author (or a person having a copyright) of the images is seriously damaged.

To prevent such the illegal reproduction, a reproduction system is proposed which inputs digital images (which is, hereinafter, referred to as “digital image data” or “image data”), encrypts the digital image data, and decrypts the encrypted digital image data to reproduce them with a legal decryption key. However, after the encrypted image data are decrypted, it is impossible to prevent reproduction of the digital image data.

To overcome the problem, another method is proposed which inserts (embeds) special information (hereinafter, the information is referred to as “electronic watermarking data”) into digital images. As the special information, two kinds of data have been thought, that is, visible electronic watermarking data and invisible electronic watermarking data.

The visible electronic watermarking data are inserted (embedded) into digital images by inserting special characters or special symbols into the digital images so that the watermarking data can be visually recognized. The insertion of the visible electronic watermarking data causes a degradation of an image quality, but it visually calls a user of the digital images to attention of a prohibition of illegal diversion.

A method of inserting the visible electronic watermarking data is disclosed in Japanese Laid Open Publication No. H8-241403. The method inserts the visible electronic watermarking data into original digital images by changing scaling values of only luminance components of pixels corresponding to opaque parts of the electronic watermarking data, without changing color components. The scaling values are decided based on the color components, random numbers, values of pixels of the electronic watermarking data.

On the other hand, the invisible electronic watermarking data are inserted into digital images considering an image quality. It is impossible to visually sense the watermarking data since there is little degradation of an image quality of the digital images caused by an insertion of the electronic watermarking data. If information which can identify an author (a person having a copyright) is inserted as the electronic watermarking data using the technique, the author can be easily specified about illegally copied digital images by detecting the inserted information. Further, if information which expresses prohibition of reproduction is inserted as the electronic watermarking data using the technique, when a reproducing device which (re)plays digital images detects the information, it is possible to notify a user of the digital images that the digital images are prohibited from reproducing (copying), or operate a reproducing prohibition mechanism in the reproducing device to prevent copying the digital images.

A method is known which inserts the invisible electronic watermarking data into digital images. In the method, special information is inserted as electronic watermarking data in a part, of the digital images, having little effect on an image quality of the digital images, for example, in an LSB (least significant bit) of pixel data. However, in the method, it is not difficult to remove the electronic watermarking data from the digital images. For example, the electronic watermarking data can be removed without significant degradation of an image quality, by performing a low pass filtering of the digital images in which the electronic watermarking data are inserted, to remove the inserted information in the LSB. Also, an image compression process can remove the electronic watermarking data without significant degradation of an image quality, by reducing an amount of information in the part having little effect on an image quality.

Another conventional method is disclosed in Japanese Laid Open Publication No. H6-315131. First, the method detects an area where an image quality is not changed if data in the area are replaced by data in the surrounding area in playing digital images, using a correlation between image qualities of continuous frames of the digital images. Then, the method changes a level of the detected area and inserts specific information into the area. The technique detects electronic watermarking data and restores the digital images, by amending data in the area using a lack part of signals and changing information when the digital images are played.

Further, another conventional method is disclosed in Japanese Laid Open Publication No. H5-30466. The method performs a frequency conversion of image signals and then, inserts information having signals of lower frequency than a frequency band of the converted image signals. The technique detects original image signals by using a high pass filter and detects the inserted information by using a low pass filter.

Another conventional method which performs a frequency conversion of image signals is still disclosed in “Nikkei Electronics”, Apr. 22, 1996 (no. 660), page 13, “Development of a method for embedding ID information into digital work at NEC”, reported by Naoki Asami. In this method, a frequency conversion of image signals is performed and then, electronic watermarking data are inserted in an area where a frequency component in the converted image signals is large. In the method, the electronic watermarking data are not lost even if a compression/decompression process or filtering is performed on the image signals, since the electronic watermarking data are inserted in the area where a frequency component in the converted image signals is large. In this case, it is impossible to remove the electronic watermarking data without destroying original digital images. Further, the technique prevents an interference between plural sets of the electronic watermarking data by using random numbers which are based on the normal distribution as the electronic watermarking data. Also, the technique prevents a degradation of an image quality by embedding the electronic watermarking data.

In the method disclosed in the above mentioned magazine “Nikkei Electronics Apr. 22, 1996 (no. 660), original digital images are converted into frequency components by using the DCT (Discrete Cosine Transform) and n sets of digital images f(1), f(2), . . . , f(n) each of which has a large value in a frequency domain are selected. Further, the method selects n of electronic watermarking data based on the normal distribution defined by an average value of zero and a variance of one.

And then, the method calculates the following equation (1) for each i. Herein, α is a scaling element.

F(i)=f(i)+α×|f(i)|×w(i) (1)

Further, digital images are given in which the electronic watermarking data are inserted by performing the inverse DCT on F(i).

Detection of the electronic watermarking data is performed as follows. In the detecting method, the digital images f(i) and candidates of electronic watermarking data w(i) (i=1, 2, 3, . . . , n) should be known.

First, the digital images in which the electronic watermarking data are inserted are converted into frequency components by using the DCT or the like. Herein, it is assumed that values of elements corresponding to digital images f(1), f(2), . . . , f(n) are represented as F(1), F(2), . . . , F(n).

Then, the electronic watermarking data W(i) are calculated by using the following equation (2) and extracted from the digital images.

W(i)=(F(i)−f(i))/f(i) (2)

Next, a degree of a statistical similarity between w(i) and W(i) is calculated by using an inner product of vectors as shown in the following equation (3).

C=W·w/(WD×wD) (3)

Herein, W=(W(1), W(2), . . . , W(n)), w=(w(1), w(2), . . . , w(n)), WD is an absolute value of a vector W, wD is an absolute value of a vector w, and “·” is an operator representing an inner product of vectors.

When a value of the degree of the statistical similarity C is larger than a specific value, it is determined that the electronic watermarking data are inserted.

If electronic watermarking data are inserted into original digital images using the technique, a person having the original digital images and a copyright of them can detect illegal copy of the digital images. In the technique, the original digital images are required, therefore, it is possible to detect the electronic watermarking data when the person having the original digital images performs a detection process of illegal copy about possible digital images. However, in a playing device of each terminal, the technique is not used to detect the electronic watermarking data since the original digital images are not included in the playing device.

Then, a method is proposed which is adapted to MPEG (moving picture experts group) system by improving the above method. In the method, the original digital images (a picture image) are divided into blocks each of which includes eight pixels by eight pixels, and an insertion process and an extraction process of the electronic watermarking data are performed for each block.

In the insertion process, first, in an MPEG coding, original digital images are converted into frequency components. Plural sets of the converted digital images are arranged in ascending order of a value of the frequency component of an AC component in a frequency domain, and defined as f(1), f(2), . . . , f(n) in the order. Also, electronic watermarking data w(1), w(2), . . . , w(n) are selected based on the normal distribution defined by an average value of zero and a variance of one.

Then, a calculation is made by using the following equation (4) for each i.

F(i)=f(i)+α×avg(f(i))×w(i) (4)

Herein, α is a scaling element, and avg (f(i)) is a partial average obtained by averaging absolute values of three neighborhood points in f(i).

And then, using f(i) instead of F(i), the following process of the MPEG coding is performed.

On the other hand, detection of the electronic watermarking data is performed as follows. In the detection process, the original digital images are not required, and it is enough that a candidate of the electronic watermarking data w(i) (i=1, 2, . . . , n) is known.

A plurality of blocks each of which is obtained by an inverse quantization of MPEG decoding are arranged in ascending order of a value of frequency component in a frequency domain, and defined as F(1), F(2), . . . , F(n) in the order. An average value of absolute values of three neighboring points of F(i), that is, F(i−1), F(i), F(i+1) is defined as a partial average avg(F(i)).

Then, the electronic watermarking data W(i) is calculated by using the following equation (5).

W(i)=F(i)/avg(F(i)) (5)

Further, the sum total WF(i) of W(i) in an image is calculated for each i.

Next, a degree of a statistical similarity between w(i) and WF(i) is calculated by using an inner product of vectors as shown in the following equation (6).

C=WF·w/(WFD×wD) (6)

When a value of the degree of the statistical similarity C is larger than a specific value, it is determined that the electronic watermarking data are inserted.

Furthermore, another method is disclosed in Japanese Laid Open Publication No. 2000-216988. The method can correctly detect, even if plural sets of electronic watermarking data are inserted, the sets of electronic watermarking data. First, the method divides digital images (a picture image) into plural blocks each of which is composed of j pixels by k pixels (each of j and k is a natural number). And the method performs a frequency conversion for each block to obtain frequency components. Then the method inserts plural kinds of electronic watermarking data for each block on inserting electronic watermarking data in the frequency components.

Also, the method performs a frequency conversion for each block which is composed of j pixels by k pixels (each of j and k is a natural number), and extracts the plural kinds of electronic watermarking data for each block on extracting electronic watermarking data from the frequency components.

In the technique disclosed in Japanese Laid Open Publication No. H6-315131, it is difficult to prevent illegal reproduction (copy) of frames in which electronic watermarking data are not inserted, since the electronic watermarking data are not inserted all frames. Also, the technique presumes that continuous frames are still images and there is no change in the continuous frames. Therefore, it is difficult to specify an area where the electronic watermarking are to be inserted in a moving picture including an expression of an object moving excitingly. That is, in the method, the electronic watermarking data cannot be inserted in such the moving picture.

In the technique disclosed in Japanese Laid Open Publication No. H5-30466, electronic watermarking data can be easily removed by using high pass filter, since the electronic watermarking data are inserted into a frequency band which is lower than a frequency of a frequency domain after a frequency conversion is performed on digital images.

Also, in the technique described in the above magazine “Nikkei Electronics Apr. 22, 1996 (no. 660)”, electronic watermarking data cannot be removed by using a filter or the like. However, in the technique, when plural sets of electronic watermarking data are inserted, detection rates of the sets of electronic watermarking data are decreased due to an offsetting by the sets of the electronic watermarking data.

Further, in the technique disclosed in Japanese Laid Open Publication No. 2000-216988, it is difficult to remove electronic watermarking data. However, in the technique, when electronic watermarking data are inserted into a picture image in which other electronic watermarking data have been already inserted, both of the electronic watermarking data are offset, since plural kinds of electronic watermarking data are inserted for each block. Also, the technique removes electronic watermarking data which are inserted before by overwriting new electronic watermarking data.

It is desirable to provide a user with an electronic watermarking insertion/detection device which is capable of preventing illegal reproduction (copy) of digital images.

### SUMMARY OF THE INVENTION:

Therefore, it is an object of the invention to provide an electronic watermarking data insertion/detection device which is capable of preventing illegal reproduction of digital images.

It is another object of the invention to provide an electronic watermarking data insertion/detection device which inserts (embeds) an identification data (electronic watermarking data) having special information into digital images, and detects the electronic watermarking data from the digital images.

Further, it is an object of the invention to provide an electronic watermarking data insertion/detection device which, even if electronic watermarking data have been inserted into a picture image, can insert other electronic watermarking data into the image without offsetting of these electronic watermarking data, and can correctly detect each of these electronic watermarking data.

Still further, it is an object of the invention to provide an electronic watermarking data insertion/detection device which can prevent removing of electronic watermarking data which have been inserted before due to overwriting of new electronic watermarking data, and can correctly detect both the electronic watermarking data.

According to a first aspect of the invention,there is provided an electronic watermarking data insertion/detection device comprising a first data analyzing unit which inputs original image data divided into a plurality of blocks each of which includes pixels and converts the image data into a plurality of first frequency components for each block and an insertion unit which inserts electronic watermarking data including special information into the first frequency components. Further, the insertion unit inserts plural kinds of electronic watermarking data into at least one of the blocks.

According to a second aspect of the invention, there is provided an electronic watermarking data insertion/detection device comprising a second data analyzing unit which inputs image data which include inserted electronic watermarking data containing special information and are divided into a plurality of blocks each of which includes pixels, and converts the image data into a plurality of second frequency components for each block and a detection unit which detects the inserted electronic watermarking data from the image data based on the second frequency components. Further, the detection unit detects plural kinds of electronic watermarking data from at least one of blocks in which the electronic watermarking data are inserted.

According to a third aspect of the invention, there is provided an electronic watermarking data insertion/detection device comprising a first data analyzing unit which inputs original image data divided into a plurality of first blocks each of which includes pixels and converts the image data into a plurality of first frequency components for each first block, an insertion unit which inserts electronic watermarking data including special information into the first frequency components, a second data analyzing unit which inputs image data which include the inserted electronic watermarking data and are divided into a plurality of second blocks each of which includes pixels, and converts the image data into a plurality of second frequency components for each second block, and a detection unit which detects the inserted electronic watermarking data from the image data based on the second frequency components. Further, the insertion unit inserts plural kinds of electronic watermarking data into at least one of the first blocks, and the detection unit detects plural kinds of electronic watermarking data from at least one of second blocks in which the electronic watermarking data are inserted.

According to a fourth aspect of the invention, there is provided an electronic watermarking data insertion/detection device based on the first or third aspect of the invention. The device further comprises an insertion number designation table which stores insertion numbers specifying the plural kinds of electronic watermarking data to be inserted and a first electronic watermarking data table which stores the plural kinds of electronic watermarking data. Further, the insertion unit fetches the plural kinds of electronic watermarking data corresponding to the insertion numbers stored in the insertion number designation table, from the first electronic watermarking data table.

According to a fifth aspect of the invention, there is provided an electronic watermarking data insertion/detection device comprising a first data analyzing unit which inputs image data which include inserted first electronic watermarking data- including special information and are divided into a plurality of blocks each of which includes pixels, and converts the image data into a plurality of first frequency components for each block, and an insertion unit which inserts second electronic watermarking data other than the first electronic watermarking data into the plurality of first frequency components. Further, the insertion unit inserts the second electronic watermarking data into at least one of the blocks, and the first electronic watermarking data and the second electronic watermarking data are inserted into the at least one of the blocks.

According to a sixth aspect of the invention, there is provided an electronic watermarking data insertion/detection device comprising a first data analyzing unit which inputs first image data which include inserted first electronic watermarking data including special information and are divided into a plurality of blocks each of which includes pixels, and converts the image data into a plurality of first frequency components for each block, and an insertion unit which inserts second electronic watermarking data other than the first electronic watermarking data into the plurality of first frequency components. Further, the insertion unit inserts the second electronic watermarking data into at least one of the block, the first electronic watermarking data and the second electronic watermarking data are inserted into the at least one of the block, and the device further comprises a second data analyzing unit which inputs second image data in which plural kinds of electronic watermarking data are inserted and converts the second image data into a plurality of second frequency components for each block of pixels and a detection unit which detects the first electronic watermarking data and second electronic watermarking data from the second image data based on the plurality of second frequency components.

According to a seventh aspect of the invention, there is provided an electronic watermarking data insertion/detection device based on the fifth or sixth aspect of the invention. The device further comprises an insertion number designation table which stores insertion numbers specifying the plural kinds of electronic watermarking data to be inserted, and a first electronic watermarking data table which stores the plural kinds of electronic watermarking data. Further, the insertion unit fetches the second electronic watermarking data corresponding to the insertion numbers stored in the insertion number designation table, from the first electronic watermarking data table.

According to an eighth aspect of the invention, there is provided an electronic watermarking data insertion/detection device based on the second, the third, or the sixth aspect of the invention. The device further comprises an extraction number designation table which stores extraction numbers specifying the plural kinds of electronic watermarking data to be extracted, and an extraction unit which extracts the extraction number from the extraction number designation table for each second frequency component supplied from the second data analyzing unit. Further, the extraction unit extracts one of the plural kinds of electronic watermarking data for each second frequency component.

According to a ninth aspect of the invention, there is provided an electronic watermarking data insertion/detection device based on the eighth aspect of the invention. The device further comprises a second electronic watermarking data table which stores the plural kinds of electronic watermarking data, wherein the extraction unit calculates a degree of a statistical similarity based on the electronic watermarking data extracted by the extraction unit and the electronic watermarking data stored the second electronic watermarking data table.

According to a tenth aspect of the invention, there is provided a method of inserting electronic watermarking data comprising the steps of inputting original image data divided into a plurality of blocks each of which includes pixels and converting the image data into a plurality of first frequency components for each block, and inserting electronic watermarking data including special information into the first frequency components. Wherein, the inserting step inserts plural kinds of electronic watermarking data into at least one of the blocks.

According to an eleventh aspect of the invention, there is provided a method of detecting electronic watermarking data comprising the steps of inputting image data which include inserted electronic watermarking data containing special information and are divided into a plurality of blocks each of which includes pixels, and converting the image data into a plurality of second frequency components for each block, and detecting the inserted electronic watermarking data from the image data based on the second frequency components. Wherein, the detecting step detects plural kinds of electronic watermarking data from at least one of blocks in which the electronic watermarking data are inserted.

According to a twelfth aspect of the invention, there is provided a method of inserting/detecting electronic watermarking data comprising the steps of inputting original image data divided into a plurality of first blocks each of which includes pixels and converting the image data into a plurality of first frequency components for each first block, inserting electronic watermarking data including special information into the first frequency components, inputting image data which include the inserted electronic watermarking data and are divided into a plurality of second blocks each of which includes pixels, and converting the image data into a plurality of second frequency components for each second block, and detecting the inserted electronic watermarking data from the image data based on the second frequency components. Wherein, the inserting step inserts plural kinds of electronic watermarking data into at least one of the first blocks, and the detecting step detects plural kinds of electronic watermarking data from at least one of second blocks in which the electronic watermarking data are inserted.

According to a thirteenth aspect of the invention, there is provided a recording medium readable by a computer, tangibly embodying a program of instructions executable by the computer to perform a method of inserting electronic watermarking data comprising the steps of inputting original image data divided into a plurality of blocks each of which includes pixels and converting the image data into a plurality of first frequency components for each block, and inserting electronic watermarking data including special information into the first frequency components. Wherein, the inserting step inserts plural kinds of electronic watermarking data into at least one of the blocks.

According to a fourteenth aspect of the invention, there is provided a recording medium readable by a computer, tangibly embodying a program of instructions executable by the computer to perform a method of detecting electronic watermarking data comprising the steps of inputting image data which include inserted electronic watermarking data containing special information and are divided into a plurality of blocks each of which includes pixels, and converting the image data into a plurality of second frequency components for each block, and detecting the inserted electronic watermarking data from the image data based on the second frequency components. Wherein, the detecting step detects plural kinds of electronic watermarking data from at least one of blocks in which the electronic watermarking data are inserted.

According to a fifteenth aspect of the invention, there is provided a recording medium readable by a computer, tangibly embodying a program of instructions executable by the computer to perform a method of inserting/detecting electronic watermarking data comprising the steps of inputting original image data divided into a plurality of first blocks each of which includes pixels and converting the image data into a plurality of first frequency components for each first block, inserting electronic watermarking data including special information into the first frequency components, inputting image data which include the inserted electronic watermarking data and are divided into a plurality of second blocks each of which includes pixels, and converting the image data into a plurality of second frequency components for each second block, and detecting the inserted electronic watermarking data from the image data based on the second frequency components. Wherein, the inserting step inserts plural kinds of electronic watermarking data into at least one of the first blocks, and the detecting step detects plural kinds of electronic watermarking data from at least one of second blocks in which the electronic watermarking data are inserted.

According to a sixteenth aspect of the invention, there is provided a program product comprising, computer readable instructions and a recording medium bearing the computer readable instructions. The instructions are adaptable to enable a computer to perform a method of inserting electronic watermarking data comprising the steps of inputting original image data divided into a plurality of blocks each of which includes pixels and converting the image data into a plurality of first frequency components for each block, and inserting electronic watermarking data including special information into the first frequency components. Wherein, the inserting step inserts plural kinds of electronic watermarking data into at least one of the blocks.

According to a seventeenth aspect of the invention, there is provided a program product comprising, computer readable instructions and a recording medium bearing the computer readable instructions. The instructions are adaptable to enable a computer to perform a method of detecting electronic watermarking data comprising the steps of inputting image data which include inserted electronic watermarking data containing special information and are divided into a plurality of blocks each of which includes pixels, and converting the image data into a plurality of second frequency components for each block, and detecting the inserted electronic watermarking data from the image data based on the second frequency components. Wherein, the detecting step detects plural kinds of electronic watermarking data from at least one of blocks in which the electronic watermarking data are inserted.

According to an eighteenth aspect of the invention, there is provided a program product comprising, computer readable instructions and a recording medium bearing the computer readable instructions. The instructions are adaptable to enable a computer to perform a method of inserting/detecting electronic watermarking data comprising the steps of inputting original image data divided into a plurality of first blocks each of which includes pixels and converting the image data into a plurality of first frequency components for each first block, inserting electronic watermarking data including special information into the first frequency components, inputting image data which include the inserted electronic watermarking data and are divided into a plurality of second blocks each of which includes pixels, and converting the image data into a plurality of second frequency components for each second block, and detecting the inserted electronic watermarking data from the image data based on the second frequency components. Wherein, the inserting step inserts plural kinds of electronic watermarking data into at least one of the first blocks, and the detecting step detects plural kinds of electronic watermarking data from at least one of second blocks in which the electronic watermarking data are inserted.

### BRIEF DESCRIPTION OF THE DRAWINGS:

FIG. 1 shows a block diagram of an electronic watermarking data insertion/detection device according to a first embodiment of the invention,

FIG. 2 shows a block diagram of en electronic watermarking data insertion system of the electronic watermarking data insertion/detection device according to the first embodiment of the invention;

FIG. 3 shows a block diagram of an electronic watermarking data detection system of the electronic watermarking data insertion/detection device according to the first embodiment of the invention;

FIG. 4 shows a flowchart representing an operation of the electronic watermarking data insertion system of the electronic watermarking data insertion/detection device according to the first embodiment of the invention;

FIG. 5 shows a flowchart representing an operation of the electronic watermarking data detection system of the electronic watermarking data insertion/detection device according to the first embodiment of the invention;

FIG. 6 shows a schematic diagram representing an order of numbers of quantized DCT coefficients;

FIG. 7 shows a schematic diagram representing values in an electronic watermarking data insertion DCT coefficient designation table and values an electronic watermarking data extraction DCT coefficient designation table;

FIG. 8 shows a block diagram of an electronic watermarking data insertion/detection device according to a second embodiment of the invention;

FIG. 9 shows a block diagram of en electronic watermarking data insertion system of the electronic watermarking data insertion/detection device according to the second embodiment of the invention;

FIG. 10 shows a diagram representing DCT coefficients in which a first electronic watermarking data are inserted;

FIG. 11 shows a diagram representing DCT coefficients in which a second electronic watermarking data are inserted; and

FIG. 12 shows a flowchart representing an operation of the electronic watermarking data insertion system of the electronic watermarking data insertion/detection device according to the second embodiment of the invention.

### DESCRIPTION OF THE PREFERRED EMBODIMENT

First,

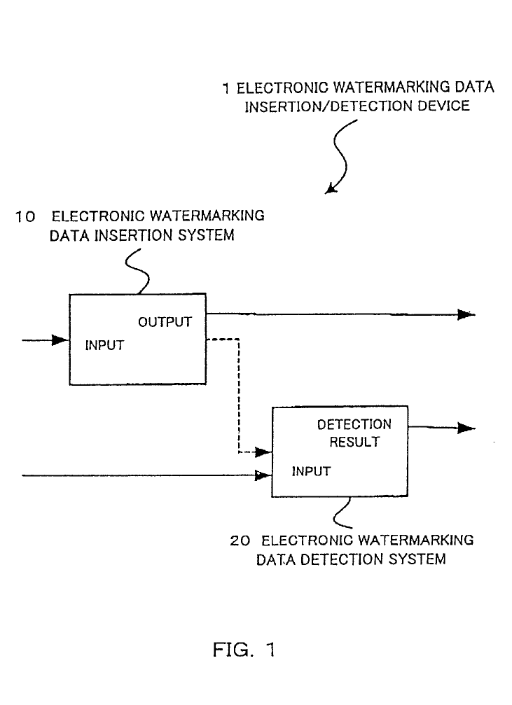

description is made about an electronic watermarking data insertion/detection device according to a first embodiment of the invention with reference to FIGS. 1-3.

The electronic watermarking data insertion/detection device 1 shown in FIG. 1 includes an electronic watermarking data insertion system 10 and an electronic watermarking data detection system 20. Electronic watermarking data include special information (or control information) to prevent illegal use or illegal reproduction (copy) of digital image.

The electronic watermarking data insertion system 10 inputs digital images as image data and converts the image data into frequency components by using the DCT (Discrete Cosine Transform) or the like for each block of pixels. The system 10 further fetches the converted frequency components (hereinafter, which are referred to as “DCT coefficients”) and inserts (or embeds) electronic watermarking data into the fetched DCT coefficients. The system 10 can insert plural kinds of electronic watermarking data in a block.

Electronic watermarking data detection system 20 inputs image data in which electronic watermarking data are inserted, and converts the image data into frequency components by using the DCT (Discrete Cosine Transform) or the like for each block. The system 20 further fetches the converted frequency components (DCT coefficients) and extracts (or detects) electronic watermarking data from the fetched DCT coefficients for each of the fetched DCT coefficients. The system 20 can extract (detect) plural kinds of electronic watermarking data inserted in a block.

Furthermore, as shown by dotted line, the insertion process and detection process at the electronic watermarking data insertion/detection device 1 can be verified according to a user's setting. The verifying operation is done by extracting, at the electronic watermarking data detection system 20, the electronic watermarking data from the image data in which electronic watermarking data are inserted at the electronic watermarking data insertion system 10.

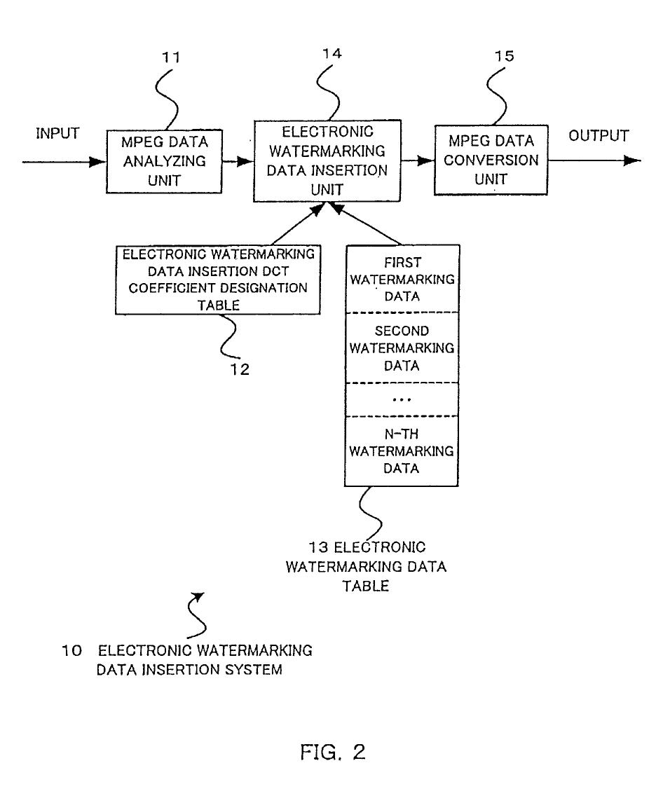

As shown in FIG. 2, the electronic watermarking data insertion system 10 includes an MPEG data analyzing unit 11, an electronic watermarking data insertion DCT coefficient designation table 12, an electronic watermarking data table 13, an electronic watermarking data insertion unit 14, and an MPEG data conversion unit 15. The MPEG data analyzing unit 11 serves as an input unit and is connected to the electronic watermarking data insertion unit 14. The electronic watermarking data insertion DCT coefficient designation table 12 and the electronic watermarking data table 13 are connected to the electronic watermarking data insertion unit 14. The MPEG data conversion unit 15 serves as an output unit and is further connected to the electronic watermarking data insertion unit 14.

The MPEG data analyzing unit 11 inputs digital images as image data and converts the image data into frequency components by using the DCT (Discrete Cosine Transform) or the like for each block. And then the unit 11 further fetches the converted frequency components (DCT coefficients).

The electronic watermarking data insertion DCT coefficient designation table 12 stores ID numbers of electronic watermarking data to be inserted. Each of the ID numbers specifies one of n kinds of electronic watermarking data which are to be inserted into a DCT coefficient, and the DCT coefficient is selected from 64 DCT coefficients, which are arranged in a one-dimensional array. The electronic watermarking data table 13 stores n kinds of electronic watermarking data (first electronic watermarking data to n-th electronic watermarking data) which are calculated to obtain appropriate values for each DCT coefficient.

The electronic watermarking data insertion unit 14 fetches the ID number of electronic watermarking data to be inserted from the electronic watermarking data insertion DCT coefficient designation table 12 according to a DCT coefficient supplied from the MPEG data analyzing unit 11, and fetches electronic watermarking data corresponding to the fetched ID number from the electronic watermarking data table 13. And then the unit 14 inserts the fetched electronic watermarking data into the DCT coefficient supplied from the MPEG data analyzing unit 11. The MPEG data conversion unit 15 quantizes the DCT coefficient in which the fetched electronic watermarking data are inserted, and outputs the quantized DCT coefficient as MPEG data.

Thereby, the electronic watermarking data insertion system 10 can insert plural kinds of electronic watermarking data in a block by (1) entering digital images as image data, (2) converting the entered image data into frequency components with the DCT or the like for each block of pixels, (3) fetching the converted frequency components (DCT coefficients), and (4) inserting the fetched DCT coefficients into electronic watermarking data.

Also, the system 10 includes the electronic watermarking data insertion DCT coefficient designation table 12 which contains information showing which electronic watermarking data are to be inserted into which DCT coefficient, and can insert electronic watermarking data corresponding to the ID number shown in the table 12.

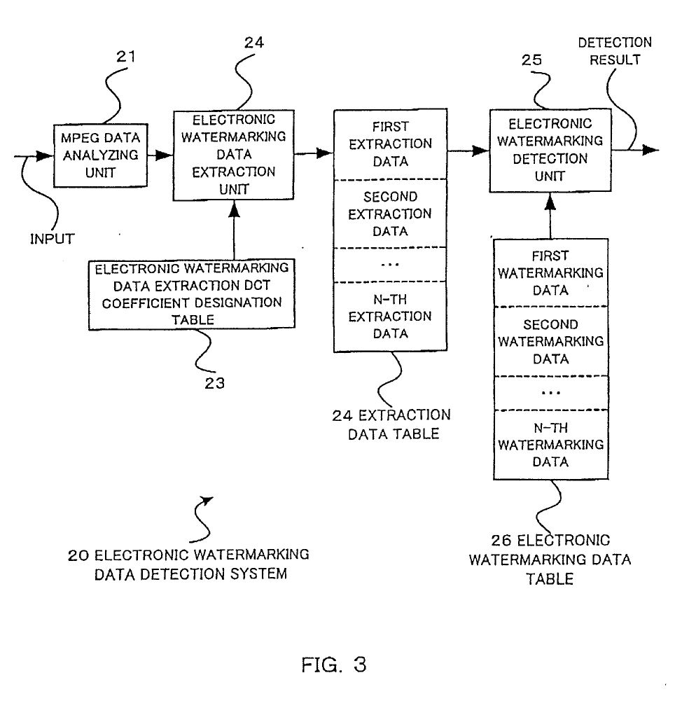

As shown in FIG. 3, the electronic watermarking data detection system 20 includes an MPEG data analyzing unit 21, an electronic watermarking data extraction unit 22, an electronic watermarking data extraction DCT coefficient designation table 23, an extraction data table 24, an electronic watermarking data detection unit 25, and an electronic watermarking data table 26. The MPEG data analyzing unit 21 serves as an input unit and is connected to the electronic watermarking data extraction unit 22. The electronic watermarking data extraction unit 22 is connected to the electronic watermarking data extraction DCT coefficient designation table 23. The extraction data table 24 is connected to the electronic watermarking data extraction unit 22. The electronic watermarking data detection unit 25 serves as an output unit and is connected to the extraction data table 24 and the electronic watermarking data table 26.

The MPEG data analyzing unit 21 inputs image data (MPEG data) in which electronic watermarking data are inserted, and converts the MPEG data into frequency components by using the DCT (Discrete Cosine Transform) or the like for each block of pixels. And then the unit 21 further fetches the converted frequency components (DCT coefficients).

The electronic watermarking data extraction DCT coefficient designation table 23 stores ID numbers of electronic watermarking data to be extracted.

Each of the ID numbers specifies one of n kinds of electronic watermarking data which are to be extracted from a DCT coefficient, and the DCT coefficient is selected from 64 DCT coefficients, which are arranged in a one-dimensional array.

The extraction data table 24 stores data extracted from each DCT coefficient.

The electronic watermarking data table 26 stores n kinds of electronic watermarking data.

The electronic watermarking data extraction unit 22 fetches the ID numbers of electronic watermarking data to be extracted from the electronic watermarking data extraction DCT coefficient designation table 23, for each DCT coefficient supplied from the MPEG data analyzing unit 21. Also, the electronic watermarking data extraction unit 22 extracts electronic watermarking data from the DCT coefficients and stores the extracted data into predetermined locations in the extraction data table 24. The electronic watermarking data extraction unit 25 fetches the m-th data (m=1, 2, . . . ,n) from the electronic watermarking data table 26 and the extraction data table 24 and calculates a degree of a statistical similarity between the extracted data and the electronic watermarking data.

Thereby, the electronic watermarking data extraction system 20 can extract (detect) plural kinds of electronic watermarking data in a block by (1) entering image data in which electronic watermarking data are inserted, (2) converting the entered image data into frequency components with the DCT or the like for each block of pixels, (3) fetching the converted frequency components (DOT coefficients), and (4) extracting the inserted electronic watermarking data from the fetched DCT coefficients.

Also, the system 20 includes the electronic watermarking data extraction DOT coefficient designation table 23 which contains information showing which kind of electronic watermarking data are inserted into which DOT coefficient, and can extract electronic watermarking data for each DOT coefficient in which electronic watermarking data are inserted. Further, the system 20 can detect electronic watermarking data by calculating a degree of a similarity between the extracted electronic watermarking data and electronic watermarking data corresponding to an ID number shown by the electronic watermarking data extraction DOT coefficient designation table 23.

In the embodiment of the invention, contents of a pair of the electronic watermarking data tables and a pair of the electronic watermarking data extraction DCT coefficient designation tables should be coincident between at insertion side and extraction side. That is, the m-th (m=1, 2, . . . , n) contents of electronic watermarking data table at the insertion side should be coincident with the corresponding m-th contents of electronic watermarking data table at the extraction side.

As described above, the electronic watermarking data insertion/detection device 1 according to the first embodiment of the invention inserts (embeds) electronic watermarking data having special information into image data by the electronic watermarking data insertion system 10, and detects the electronic watermarking data from the image data by the electronic watermarking data detection system 20.

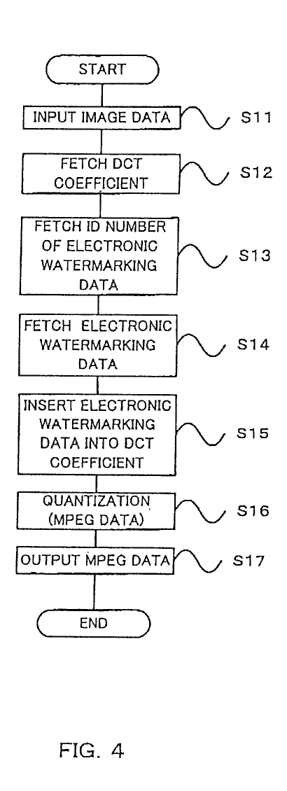

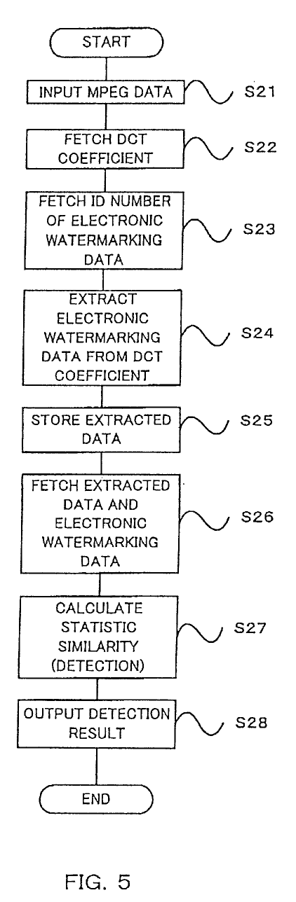

Next, description is made about an operation of the above described electronic watermarking data insertion/detection device 1 with reference to FIGS. 4 and 5.

The operation of the electronic watermarking data insertion/detection device 1 consists of (1) an electronic watermarking data inserting process by the electronic watermarking data insertion system 10 and (2) an electronic watermarking data detecting process by the electronic watermarking data detection system 20.

First, description is made about the electronic watermarking data inserting process with reference to FIG. 4.

As shown FIG. 4, the MPEG data analyzing unit 11 inputs digital images as image data (step S11). Then, the unit 11 converts the image data into frequency components for each block of pixels and fetches the converted frequency components (DCT coefficients) from the block (step S12).

Then, the electronic watermarking data insertion unit 14 fetches an ID number of electronic watermarking data to be inserted from the electronic watermarking data insertion DCT coefficient designation table 12 according to each DCT coefficient supplied from the MPEG data analyzing unit 11 (step S13). Next, the unit 14 fetches from the electronic watermarking data table 13 electronic watermarking data corresponding to the fetched ID number (step S14). After that, the unit 14 inserts the fetched electronic watermarking data into the DCT coefficient supplied from the MPEG data analyzing unit 11 (step S15). Consequently, the MPEG data conversion unit 15 quantizes the DCT coefficient in which the fetched electronic watermarking data are inserted (step S16). And then, the unit 15 outputs the DCT coefficient which is quantized in step S16, as MPEG data (step S17).

In the electronic watermarking data inserting process, above mentioned operations are performed on all of DCT coefficients corresponding to areas where the ID numbers are placed in the electronic watermarking data insertion DCT coefficient designation table 12.

Also, DCT coefficients corresponding to areas where ID numbers are not placed in the table 13 are entered to the MPEG conversion unit 15 without any intermediate operation.

Next, description is made about the electronic watermarking data extracting process with reference to FIG. 5.

As shown in FIG. 5, the MPEG data analyzing unit 21 inputs image data (MPEG data) in which electronic watermarking data are inserted (step S21). Next, the unit 21 fetches the converted frequency components (DCT coefficients) from the block, based on the MPEG data (step S22). And then, the electronic watermarking data extraction unit 22 fetches from the electronic watermarking data extraction DCT coefficient designation table 23, ID numbers of electronic watermarking data to be extracted, for each DCT coefficient supplied from the MPEG data analyzing unit 21 (step S23).

After that, the electronic watermarking data extraction unit 22 extracts electronic watermarking data from the DCT coefficients (step S24). Next, the unit 22 stores the extracted data (extraction data) into the extraction data table 24 (step S25).

Herein, the extraction data are stored at a location in the extraction data table 24. The location is decided according to the corresponding ID number of electronic watermarking data, which is fetched from the electronic watermarking data extraction DCT coefficient designation table 23.

In the electronic watermarking data extracting process, above mentioned operations are performed on all of DCT coefficients corresponding to areas where the ID numbers are placed in the electronic watermarking data extraction DCT coefficient designation table 23.

Next, the electronic watermarking data extraction unit 25 fetches the stored extraction data from the extraction data table 24 and fetches the electronic watermarking data corresponding to the stored extraction data from the electronic watermarking data table (step S26). Then, the unit 25 calculates a degree of a statistical similarity between the stored extraction data and the fetched electronic watermarking data (step S27). After that, the unit 25 outputs a result of the calculation as a detection result (step S28).

When there are n kinds of electronic watermarking data, the unit 25 fetches for each electronic watermarking data, the corresponding extraction data from the extraction data table 24 and the corresponding electronic watermarking data from the electronic watermarking data table 26, and calculates a degree of a statistical similarity and outputs it as a detection result.

Thereby, the electronic watermarking data insertion/detection device 1 according to the first embodiment of the invention inserts (embeds) electronic watermarking data having special information into image data by the electronic watermarking data insertion system 10, and detects the electronic watermarking data from the image data by the electronic watermarking data detection system 20. Subsequently, the electronic watermarking data insertion/detection device I according to the first embodiment of the invention can prevent illegal reproduction of digital image.

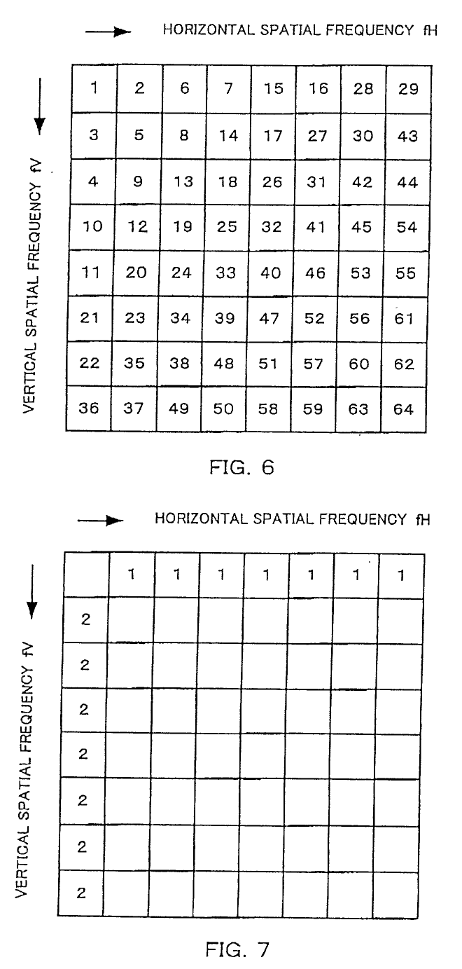

Next, description is made about an example of actual values included in the electronic watermarking data insertion DCT coefficient designation table 12 and in the electronic watermarking data extraction DCT coefficient designation table 23 which are used in the electronic watermarking data insertion/detection device 1, with reference to FIGS. 6 and 7.

FIG. 7 shows an example of the electronic watermarking data insertion DCT coefficient designation table 12 or in the electronic watermarking data extraction DCT coefficient designation table 23. Herein, horizontal spatial frequency fH are placed in a horizontal direction and vertical spatial frequency fV are placed in a vertical direction. Values of the horizontal spatial frequency fH are stored in eight columns and values of the vertical spatial frequency fV are stored in eight rows.

FIG. 6 shows an example of DCT coefficient matrix used in MPEG coding/decoding process. Each value in the matrix is quantized, for example, at the MPEG data conversion unit 15, to a value of non-zero in so-called “ZIGZAG scan”. The quantized DCT coefficients are arranged to one-dimensional array in the order of ZIGZAG scan.

As shown in FIG. 7, in the electronic watermarking data insertion DCT coefficient designation table 12 and in the electronic watermarking data extraction DCT coefficient designation table 23, plural ID numbers are included each of which shows which electronic watermarking data are to be inserted into which DCT coefficient. The electronic watermarking data insertion/detection device 1 inserts “first” electronic watermarking data designated by an ID number “1” shown in FIG. 7 into the second, sixth, seventh, fifteenth, sixteenth, twenty-eighth, and twenty-ninth DCT coefficients shown in FIG. 6.

That is, “first” electronic watermarking data corresponding to an ID number “1” are fetched, and the “first” electronic watermarking data are inserted into each DCT coefficient placed in an element of FIG. 6 which has the same low and the same column of the element including the ID number “1” of FIG. 7.

Also, the device I inserts “second” electronic watermarking data designated by an ID number “2” shown in FIG. 7 into the third, fourth, tenth, eleventh, twenty-first, twenty-second, and thirty-sixth DCT coefficients shown in FIG. 6.

Next, description in made in more detail about the above mentioned insertion of “first” and “second” electronic watermarking data with reference to FIGS. 4 and 5.

First, an electronic watermarking data inserting process by the electronic watermarking data insertion system 10 (1) of the operation of the electronic watermarking data insertion/detection device 1 is explained.

As shown in FIG. 4, the MPEG data analyzing unit 11 inputs digital images as image data (step S11). Then the unit 11 analyzes the image data and fetches DCT coefficients in an order from the lowest frequency component to the highest frequency component (that is, in an ascending order of order numbers of FIG. 6) in a form of arrangement of one-dimensional array (step S12).

Next, in step S13, the electronic watermarking data insertion unit 14 (a) fetches an ID number of electronic watermarking data “1” from the electronic watermarking data insertion DCT coefficient designation table 12 when DCT coefficient from the MPEG data analyzing unit 11 is the second, sixth, seventh, fifteenth, sixteenth, twenty-eighth, or twenty-ninth DCT coefficient, and (b) fetches an ID number of electronic watermarking data “2” from the electronic watermarking data insertion DCT coefficient designation table 12 when DCT coefficient from the MPEG data analyzing unit 11 is the third, fourth, tenth, eleventh, twenty-first, twenty-second, or thirty-sixth DCT coefficient.

Next, in step S14, the unit 14 fetches the “first” electronic watermarking data corresponding to the ID number of electronic watermarking data “1” from the electronic watermarking data table 13 in the case (a), and fetches the “second” electronic watermarking data corresponding to the ID number of electronic watermarking data “2” from the electronic watermarking data table 13 in the case (b).

And then the unit 14 inserts the “first” electronic watermarking data into a DCT coefficient supplied from the MPEG data analyzing unit 11 (that is, one of the second, sixth, seventh, fifteenth, sixteenth, twenty-eighth, and twenty-ninth DCT coefficients) and outputs the DCT coefficient to the MPEG data conversion unit 15 in the case (a) (step S15).

On the other hand, the unit 14 inserts the “second” electronic watermarking data into a DCT coefficient supplied from the MPEG data analyzing unit 11 (that is, one of the third, fourth, tenth, eleventh, twenty-first, twenty-second, and thirty-sixth DCT coefficients) and outputs the DCT coefficient to the MPEG data conversion unit 15 in the case (b) (step S15).

Herein, the electronic watermarking data insertion unit 14 outputs a DCT coefficient other than the second, sixth, seventh, fifteenth, sixteenth, twenty-eighth, twenty-ninth, third, fourth, tenth, eleventh, twenty-first, twenty-second, and thirty-sixth DCT coefficients, to the MPEG conversion unit 15 without inserting any electronic watermarking data.

Next, the MPEG data conversion unit 15 receives DCT coefficients and quantizes DCT coefficients (step S16). And then the unit 15 outputs the DCT coefficients quantized in step S16 as MPEG data (step S17).

Second, the electronic watermarking data extracting process by the electronic watermarking data extraction system 20 (2) of the operation of the electronic watermarking data insertion/detection device 1 is explained.

As shown in FIG. 5, the MPEG analyzing unit 21 inputs image data (MPEG data) in which electronic watermarking data are inserted (step S21). Then, the unit 21 analyzes the MPEG data and fetches DCT coefficients (step S22). And then, in step S23, the electronic watermarking data extraction unit 22, referring to the electronic watermarking data extraction DCT coefficient designation table 23, (d) fetches an ID number of electronic watermarking data “1” when DCT coefficient from the MPEG data analyzing unit 21 is the second, sixth, seventh, fifteenth, sixteenth, twenty-eighth, or twenty-ninth DCT coefficient, and (e) fetches an ID number of electronic watermarking data “2” when DCT coefficient from the MPEG data analyzing unit 21 is the third, fourth, tenth, eleventh, twenty-first, twenty-second, or thirty-sixth DCT coefficient.

Next, in step S24, the unit 22 extracts electronic watermarking data from one of the second, sixth, seventh, fifteenth, sixteenth, twenty-eighth, and twenty-ninth DCT coefficients in the case (c), and extracts electronic watermarking data from one of the third, fourth, tenth, eleventh, twenty-first, twenty-second, and thirty-sixth DCT coefficients in the case (d).

After that, in step S25, the unit 22 stores the extracted electronic watermarking data (extraction data) into a first extraction data table which corresponds to the ID number of electronic watermarking data “1” and is located in the extraction data table 24 in the case (c), and stores the extracted electronic watermarking data (extraction data) into a second extraction data table which corresponds to the ID number of electronic watermarking data “2” and is located in the extraction data table 24 in the case (d).

The electronic watermarking data extracting process by the electronic watermarking data extraction system 20 is performed on all of DCT coefficients included in the electronic watermarking data extraction DCT coefficient designation table 23.

Next, in step S26, after the extraction data are stored in the extraction data table 24, the electronic watermarking data extraction unit 25 fetches the first extraction data from the extraction data table 24 and fetches first electronic watermarking data from the electronic watermarking data based on the ID number of electronic watermarking data “1” in the case (c).

On the other hand, the unit 25 fetches the second extraction data from the extraction data table 24 and fetches second electronic watermarking data from the electronic watermarking data based on the ID number of electronic watermarking data “2” in the case (d).

The unit 25 then calculates a degree of a statistical similarity between the first extraction data and the first electronic watermarking data, or between the second extraction data and the second electronic watermarking data (step S27).

Next, the unit 25 outputs a result of the calculation as a detection result (step S28).

When there are n kinds of electronic watermarking data, the unit 25 fetches the extraction data and the corresponding electronic watermarking data from the electronic watermarking data table 26, calculates the degree of the statistical similarity, and outputs the detection result for each kind of electronic watermarking data.

As described above, the electronic watermarking data insertion/detection device 1 according to the first embodiment of the invention can insert electronic watermarking data without offsetting of plural kinds of electronic watermarking data when the plural kinds of electronic watermarking data are inserted in image data, since the different kinds of electronic watermarking data are inserted DCT coefficients.

A range of the electronic watermarking data insertion/detection device 1 according to the first embodiment of the invention is not limited to the above mentioned example. It is enough that the device 1 includes both or either of a function to insert electronic watermarking data and a function detect the electronic watermarking data.

When the device 1 includes either of the functions, it is desirable to have a mechanism which is capable of switching between both functions according to a user's setting.

From the above explanation, it is clear that the electronic watermarking data insertion/detection device 1 according to the first embodiment of the invention can prevent illegal reproduction of image data.

Further, the device 1 can insert (embed) electronic watermarking data and detect the electronic watermarking data from the image data.

Still further, the device 1 can insert plural kinds of electronic watermarking data in a picture image without offsetting of the watermarking data, and can detect correctly the plural kinds of electronic watermarking data in detecting the electronic watermarking data.

As described above, the electronic watermarking data insertion system 10 of the electronic watermarking data insertion/detection device 1 can insert plural kinds of electronic watermarking data without offsetting of the watermarking data since different electronic watermarking data are used for each DCT coefficient.

On the other hand, in an electronic watermarking data insertion system of the electronic watermarking data insertion/detection device according to a second embodiment of the invention, when electronic watermarking data are inserted into image data in which electronic watermarking data have been already inserted, it is effectively prevented that disablement (removal) of the originally inserted electronic watermarking data due to overwriting of the newly inserted electronic watermarking data since the new electronic watermarking data are inserted into DCT coefficients other than DCT coefficients in which electronic watermarking data have been already inserted.

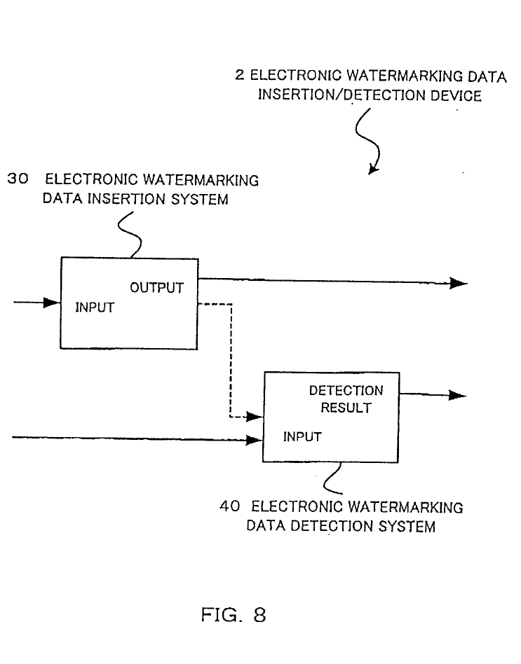

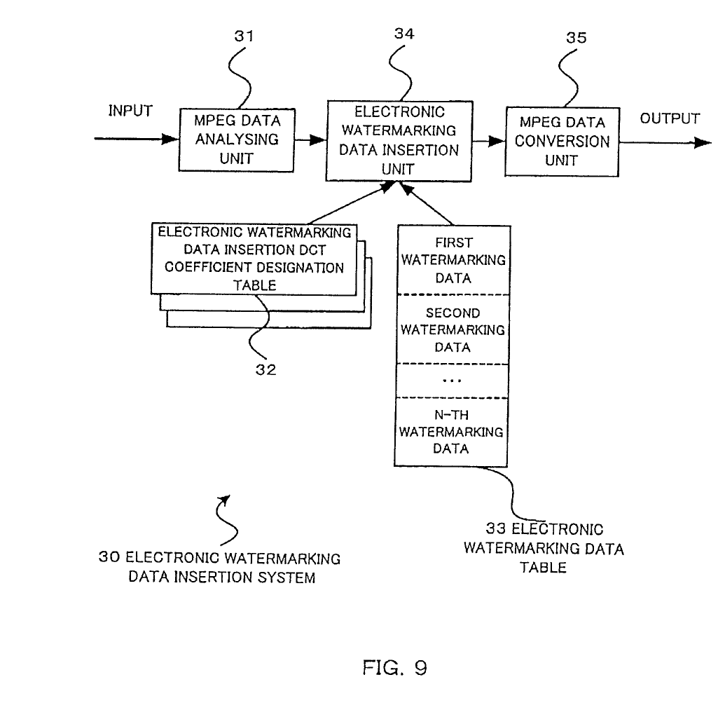

Next, description is made about a composition of the electronic watermarking data insertion/detection device 2 according to a second embodiment of the invention with reference to FIGS. 8 and 9.

As shown FIG. 8, the electronic watermarking data insertion/detection device 2 includes an electronic watermarking data insertion system 30 and an electronic watermarking data detection system 40. Electronic watermarking data include special information (or control information) to prevent illegal use and illegal reproduction of digital images.

The electronic watermarking data insertion system 30 inputs digital images as image data, and converts the image data into frequency components by using the DCT (Discrete Cosine Transform) or the like for each block of pixels. The system 30 further fetches the converted frequency components (DCT coefficients) and inserts electronic watermarking data into the fetched DCT coefficients. The system 30 can insert plural kinds of electronic watermarking data in a block.

The electronic watermarking data detection system 40 inputs the image data in which the electronic watermarking data are inserted, and converts the image data into frequency components by using the DCT (Discrete Cosine Transform) or the like for each block. And the system 40 further fetches the converted frequency components (DCT coefficients) and extracts the inserted electronic watermarking data for each fetched DCT coefficient. The system 40 can extract plural kinds of electronic watermarking data in a block.

Furthermore, as shown by dotted line, the insertion process and detection process at the electronic watermarking data insertion/detection device 2 can be verified according to a user's setting. The verifying operation is done by extracting from the image data in which electronic watermarking data are inserted at the electronic watermarking data insertion system 30, at the electronic watermarking data detection system 40, the electronic watermarking data. Also, description of a composition and an operation of the electronic watermarking data detection system 40 is omitted because the composition and the operation of the system 40 are coincident with the composition and the operation of the electronic watermarking data detection system 20 of the electronic watermarking data insertion/detection device 1.

As shown in FIG. 9, the electronic watermarking data insertion system 30 includes an MPEG data analyzing unit 31, an electronic watermarking data insertion DCT coefficient designation table 32, an electronic watermarking data table 33, an electronic watermarking data insertion unit 34, and an MPEG data conversion unit 35. The MPEG data analyzing unit 31 serves as an input unit and is connected to the electronic watermarking data insertion unit 34. The electronic watermarking data insertion DCT coefficient designation table 32 and the electronic watermarking data table 33 are connected to the electronic watermarking data insertion unit 34. The MPEG data conversion unit 15 serves as an output unit and is further connected to the electronic watermarking data insertion unit 34.

The MPEG data analyzing unit 31 inputs digital images as image data and converts the image data into frequency components by using the DCT (Discrete Cosine Transform) or the like for each block of pixels. And then the unit 31 further fetches the converted frequency components (DCT coefficients).

The unit 31 further inputs the image data which first electronic watermarking data are inserted into DCT coefficients thereof, and analyzes the image data. After that, the unit 31 fetches the DCT coefficients in an order from the lowest frequency component to the highest frequency component (that is, in an ascending order of order numbers shown in FIG. 6) in a form of one-dimensional array.

The electronic watermarking data insertion DCT coefficient designation table 32 stores ID numbers of electronic watermarking data to be inserted. Each of the ID numbers specifies one of n kinds of electronic watermarking data which are to be inserted to a DCT coefficient, and the DCT coefficient is selected from 64 DCT coefficients, which are arranged in a one-dimensional array.

The electronic watermarking data table 33 stores n kinds of electronic watermarking data (first electronic watermarking data to n-th electronic watermarking data) which are calculated to obtain appropriate values for each DCT coefficient.

The electronic watermarking data insertion unit 34 fetches an ID number of second electronic watermarking data to be inserted from the electronic watermarking data insertion DCT coefficient designation table 32 according to a DCT coefficient supplied from the MPEG data analyzing unit 31, and fetches the second electronic watermarking data corresponding to the fetched ID number from the electronic watermarking data table 33. And then the unit 34 inserts the fetched second electronic watermarking data into the DCT coefficient supplied from the MPEG data analyzing unit 31.

The MPEG data conversion unit 35 receives from the electronic watermarking data insertion unit 34 the DCT coefficient in which the fetched electronic watermarking data are inserted, quantizes the received DCT coefficient, and outputs the quantized DCT coefficient as MPEG data.

In the MPEG data supplied form the MPEG data conversion unit 35, the first electronic watermarking data and the second electronic watermarking data are inserted. Since the first and the second electronic watermarking data are inserted into the different DCT coefficients, no offsetting causes between the first and the second electronic watermarking data.

Thereby, the electronic watermarking data insertion system 30 inputs digital images as image data, and converts the image data into frequency components by using the DCT or the like for each block of pixels. And then, the system 30 fetches the converted frequency components (DCT coefficients), and inserts electronic watermarking data into the fetched DCT coefficients. Therefore, the system can plural kinds of electronic watermarking data into a block.

Also, the system 30 can prevent removing of originally inserted electronic watermarking data due to overwriting of new electronic watermarking data, by inserting (re-inserting) the new electronic watermarking data into other DCT coefficients other than DCT coefficients including the originally inserted electronic watermarking data when other electronic watermarking data are inserted into image data.

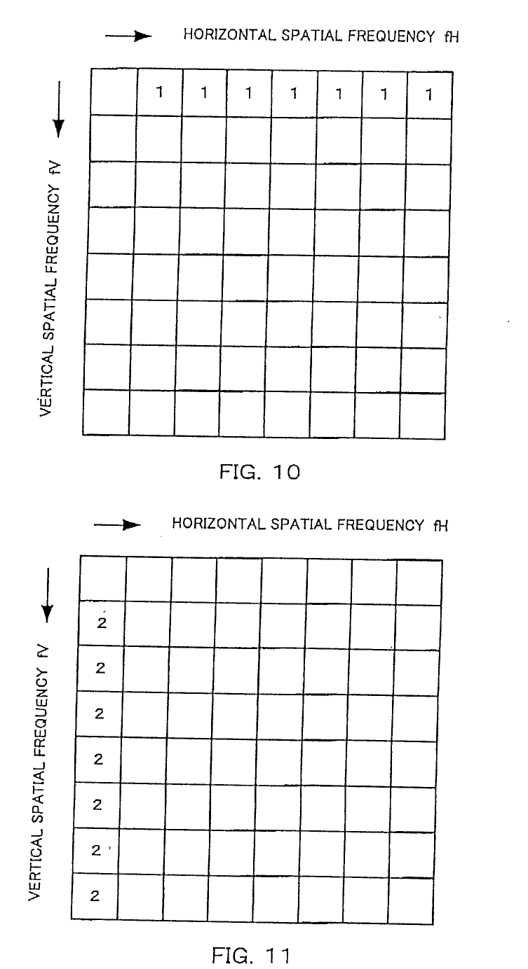

Next, description is made about a method of re-inserting electronic watermarking data with reference to FIGS. 10 and 11.

As shown FIGS. 10 and 11, in the electronic watermarking data insertion DCT coefficient designation table 32, horizontal spatial frequency fH which are inserted in a horizontal direction and vertical spatial frequency fV which are inserted in a vertical direction are included. Values of the horizontal spatial frequency fH are stored in eight columns and values of the vertical spatial frequency fV are stored in eight rows.

In the electronic watermarking data insertion DCT coefficient designation table 32, ID numbers which correspond to kinds of electronic watermarking data are stored in a two-dimensional array.

In the table 32 as shown in FIG. 10, ID number “1” is denoted from columns 2-8 in the first row. Therefore, according to contents of the table 32, the first electronic watermarking data corresponding to the ID number “1” are inserted to the corresponding DCT coefficients. Herein, each element (in FIG. 10) where the ID number “1” is stored is related to an element (in FIG. 6) in the same row and the same column of the element of FIG. 10. Therefore, the first electronic watermarking data are inserted to the second, sixth, seventh, fifteenth, sixteenth, twenty-eighth, and twenty-ninth DCT coefficients.

Similarly, in the table 32 as shown in FIG. 11, the second electronic watermarking data corresponding to the ID number “2” are inserted into the third, fourth, tenth, eleventh, twenty-first, twenty-second, and thirty-sixth DCT coefficients.

As described above, the electronic watermarking data insertion system 30 inserts, according to the two-dimensional array shown in FIG. 10, the first electronic watermarking data corresponding to ID number “1” into DCT coefficients corresponding to elements of the two-dimensional array where the ID number “1” is placed. After that, the system 30 re-inserts, according to the two-dimensional array shown in FIG. 11, the second electronic watermarking data corresponding to ID number “2” into other DCT coefficients corresponding to elements of the two-dimensional array where the ID number “2” is placed.

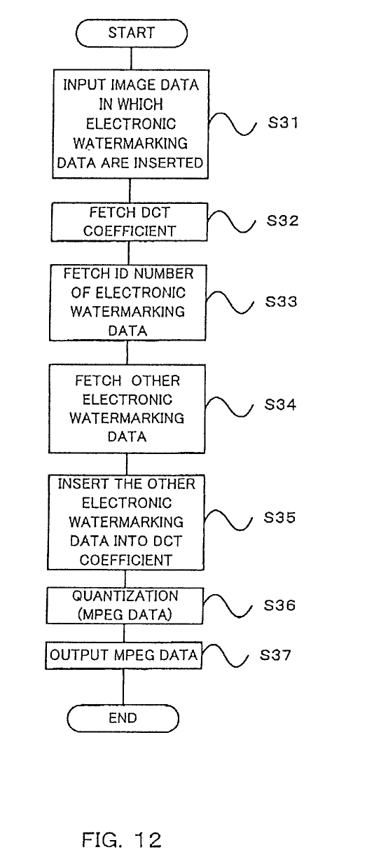

Next, description is made about an inserting process by the electronic watermarking data insertion system 30 referring to the electronic watermarking data insertion DCT coefficient designation table 32 of the electronic watermarking data insertion/detection device 2, with reference to FIGS. 6 and 12.

As shown in FIG. 12, the MPEG data analyzing unit 31 inputs, for example, image data which first electronic watermarking data are inserted into the second, sixth, seventh, fifteenth, sixteenth, twenty-eighth, and twenty-ninth DCT coefficients shown in FIG. 6 (step S31).

Next, the unit 31 analyzes the image data and fetches DCT coefficients in an order from the lowest frequency component to the highest frequency component (that is, in an ascending order of order numbers shown in FIG. 6) in a form of one-dimensional array.

Then, the electronic watermarking data insertion unit 34 fetches an ID number “2” of electronic watermarking data from the electronic watermarking data insertion DCT coefficient designation table 32 when at least one of the third, fourth, tenth, eleventh, twenty-first, twenty-second, and thirty-sixth DCT coefficients is received from the MPEG data analyzing unit 31 (step S33).

The unit 34 then fetches the second electronic watermarking data corresponding to the ID number “2” form the electronic watermarking data table 33 (step S34). And the unit 34 inserts the second electronic watermarking data into the DCT coefficients (at least one of the third, fourth, tenth, eleventh, twenty-first, twenty-second, and thirty-sixth DCT coefficients) supplied from the MPEG data analyzing unit 31, and outputs them to the MPEG data conversion unit 35 (step S35). Herein, in each of the second, sixth, seventh, fifteenth, sixteenth, twenty-eighth, and twenty-ninth DCT coefficients, the first electronic watermarking data have been already inserted.

After that, the MPEG data conversion unit 35 receives the DCT coefficients in which electronic watermarking data are inserted from the electronic watermarking data insertion unit 34, and quantizes them (step S36). Next, the unit 35 outputs the DCT coefficients which are quantized in step S36 as MPEG data (step S37).

Thereby, the first and the second electronic watermarking data are inserted into the MPEG data supplied from the unit 35. Since the first and the second electronic watermarking data are inserted into the different DCT coefficients, there is no offsetting between the first and the second electronic watermarking data.

The electronic watermarking data insertion system 30 can insert plural kinds of electronic watermarking data by inserting new electronic watermarking data into DCT coefficients in which electronic watermarking data are not inserted ever, even if electronic watermarking data have already been inserted into image data.

As described above, the electronic watermarking data insertion/detection device 2 according to the second embodiment of the invention can prevent removing of originally inserted electronic watermarking data due to overwriting of new electronic watermarking data, by inserting the new electronic watermarking data into DCT coefficients other than DCT coefficients in which the electronic watermarking data are originally inserted when the new electronic watermarking data are inserted into image data already including electronic watermarking data.

Also, the MPEG data conversion unit 31 of the electronic watermarking data insertion system 30 can be applied to an alternate scan method which is a scan method of MPEG2, as well as a method of outputting DCT coefficients in a form of one-dimensional by using a zigzag scan method.

Description of the electronic watermarking data insertion/detection device 2 according to the second embodiment of the invention has been made with reference to an example. However, a composition and an operation of the device 2 is not limited to the example. In the example, a coding process based on MPEG standard is explained, but electronic watermarking data insertion/detection of the invention can be applied to other image coding methods using DCT coefficients.

Also, it is enough that the electronic watermarking data insertion/detection device 2 includes both or either of a function to insert electronic watermarking data and a function to detection the electronic watermarking data.

When the device includes either of them, it is desirable to have a mechanism which is capable of changing the both function according to a user's setting.

As described above, in the electronic watermarking data insertion/detection device 2, in addition to an effect of the device 1, offsetting of plural kinds of electronic watermarking data due to overwriting of electronic watermarking data is effectively prevented and correct detection of the plural kinds of electronic watermarking data can be made.

What is claimed is:

1. An electronic watermarking data insertion device comprising:
a first data analyzing unit which inputs original image data divided into a plurality of blocks each of which includes pixels and converts the image data into a plurality of first frequency components for each block; and
an insertion unit which inserts electronic watermarking data including special information into the first frequency components, wherein the insertion unit inserts plural kinds of electronic watermarking data into at least one of the blocks.

2. An electronic watermarking data detection device comprising:
a second data analyzing unit which inputs image data which include inserted electronic watermarking data containing special information and are divided into a plurality of blocks each of which includes pixels, and converts the image data into a plurality of second frequency components for each block; and
a detection unit which detects the inserted electronic watermarking data from the image data based on the second frequency components, wherein the detection unit detects plural kinds of electronic watermarking data from at least one of blocks in which the electronic watermarking data are inserted.

3. An electronic watermarking data insertion/detection device comprising:
a first data analyzing unit which inputs original image data divided into a plurality of first blocks each of which includes pixels and converts the image data into a plurality of first frequency components for each first block;
an insertion unit which inserts electronic watermarking data including special information into the first frequency components;
a second data analyzing unit which inputs image data which include the inserted electronic watermarking data and are divided into a plurality of second blocks each of which includes pixels, and converts the image data into a plurality of second frequency components for each second block; and
a detection unit which detects the inserted electronic watermarking data from the image data based on the second frequency components, wherein the insertion unit inserts plural kinds of electronic watermarking data into at least one of the first blocks, and the detection unit detects plural kinds of electronic watermarking data from at least one of second blocks in which the electronic watermarking data are inserted,

4. The electronic watermarking data insertion device of claim 1 further comprising:
an insertion number designation table which stores insertion numbers specifying the plural kinds of electronic watermarking data to be inserted; and
a first electronic watermarking data table which stores the plural kinds of electronic watermarking data, wherein the insertion unit fetches the plural kinds of electronic watermarking data corresponding to the insertion numbers stored in the insertion number designation table, from the first electronic watermarking data table.

5. The electronic watermarking data detection device of claim 3 further comprising:
an insertion number designation table which stores insertion numbers specifying the plural kinds of electronic watermarking data to be inserted; and
a first electronic watermarking data table which stores the plural kinds of electronic watermarking data, wherein the insertion unit fetches the plural kinds of electronic watermarking data corresponding to the insertion numbers stored in the insertion number designation table, from the first electronic watermarking data table.

6. An electronic watermarking data insertion device comprising:
a first data analyzing unit which inputs image data which include inserted first electronic watermarking data including special information and are divided into a plurality of blocks each of which includes pixels, and converts the image data into a plurality of first frequency components for each block; and
an insertion unit which inserts second electronic watermarking data other than the first electronic watermarking data into the plurality of first frequency components, wherein the insertion unit inserts the second electronic watermarking data into at least one of the blocks, and the first electronic watermarking data and the second electronic watermarking data are inserted into the at least one of the blocks.

7. An electronic watermarking data insertion/detection device comprising:
a first data analyzing unit which inputs first image data which include inserted first electronic watermarking data including special information and are divided into a plurality of blocks each of which includes pixels, and converts the image data into a plurality of first frequency components for each block; and
an insertion unit which inserts second electronic watermarking data other than the first electronic watermarking data into the plurality of first frequency components, wherein the insertion unit inserts the second electronic watermarking data into at least one of the block, the first electronic watermarking data and the second electronic watermarking data are inserted into the at least one of the block, and the electronic watermarking data insertion/detection device further comprises a second data analyzing unit which inputs second image data in which plural kinds of electronic watermarking data are inserted and converts the second image data into a plurality of second frequency components for each block of pixels and a detection unit which detects the first electronic watermarking data and second electronic watermarking data from the second image data based on the plurality of second frequency components.

8. The electronic watermarking data insertion device of claim 6 further comprising:
an insertion number designation table which stores insertion numbers specifying the plural kinds of electronic watermarking data to be inserted; and
a first electronic watermarking data table which stores the plural kinds of electronic watermarking data, wherein the insertion unit fetches the second electronic watermarking data corresponding to the insertion numbers stored in the insertion number designation table, from the first electronic watermarking data table.

9. The electronic watermarking data insertion/detection device of claim 7 further comprising:
an insertion number designation table which stores insertion numbers specifying the plural kinds of electronic watermarking data to be inserted; and
a first electronic watermarking data table which stores the plural kinds of electronic watermarking data, wherein the insertion unit fetches the second electronic watermarking data corresponding to the insertion numbers stored in the insertion number designation table, from the first electronic watermarking data table.

10. The electronic watermarking data detection device of claim 2 further comprising:
an extraction number designation table which stores extraction numbers specifying the plural kinds of electronic watermarking data to be extracted; and
an extraction unit which extracts the extraction number from the extraction number designation table for each second frequency component supplied from the second data analyzing unit, wherein the extraction unit extracts one of the plural kinds of electronic watermarking data for each second frequency component.

11. The electronic watermarking data insertion/detection device of claim 3 further comprising:
an extraction number designation table which stores extraction numbers specifying the plural kinds of electronic watermarking data to be extracted; and
an extraction unit which extracts the extraction number from the extraction number designation table for each second frequency component supplied from the second data analyzing unit, wherein the extraction unit extracts one of the plural kinds of electronic watermarking data for each second frequency component.

12. The electronic watermarking data insertion/detection device of claim 7 further comprising:
an extraction number designation table which stores extraction numbers specifying the plural kinds of electronic watermarking data, to be extracted; and
an extraction unit which extracts the extraction number from the extraction number designation table for each second frequency component supplied from the second data analyzing unit, wherein the extraction unit extracts one of the plural kinds of electronic watermarking data for each second frequency component.

13. The electronic watermarking data detection device of claim 10 further comprising:
a second electronic watermarking data table which stores the plural kinds of electronic watermarking data, wherein the extraction unit calculates a degree of a statistical similarity based on the electronic watermarking data extracted by the extraction unit and the electronic watermarking data stored the second electronic watermarking data table.

14. The electronic watermarking data insertion/detection device of claim 11 further comprising:
a second electronic watermarking data table which stores the plural kinds of electronic watermarking data, wherein the extraction unit calculates a degree of a statistical similarity based on the electronic watermarking data extracted by the extraction unit and the electronic watermarking data stored the second electronic watermarking data table.

15. The electronic watermarking data insertion/detection device of claim 12 further comprising:
a second electronic watermarking data table which stores the plural kinds of electronic watermarking data, wherein the extraction unit calculates a degree of a statistical similarity based on the electronic watermarking data extracted by the extraction unit and the electronic watermarking data stored the second electronic watermarking data table.

16. A method of inserting electronic watermarking data comprising the steps of:
inputting original image data divided into a plurality of blocks each of which includes pixels and converting the image data into a plurality of first frequency components for each block; and
inserting electronic watermarking data including special information into the first frequency components, wherein the inserting step inserts plural kinds of electronic watermarking data into at least one of the blocks.

17. A method of detecting electronic watermarking data comprising the steps of:
inputting image data which include inserted electronic watermarking data containing special information and are divided into a plurality of blocks each of which includes pixels, and converting the image data into a plurality of second frequency components for each block; and
detecting the inserted electronic watermarking data from the image data based on the second frequency components, wherein the detecting step detects plural kinds of electronic watermarking data from at least one of blocks in which the electronic watermarking data are inserted.

18. A method of inserting/detecting electronic watermarking data comprising the steps of:
inputting original image data divided into a plurality of first blocks each of which includes pixels and converting the image data into a plurality of first frequency components for each first block;
inserting electronic watermarking data including special information into the first frequency components;
inputting image data which include the inserted electronic watermarking data and are divided into a plurality of second blocks each of which includes pixels, and converting the image data into a plurality of second frequency components for each second block; and
detecting the inserted electronic watermarking data from the image data based on the second frequency components, wherein the inserting step inserts plural kinds of electronic watermarking data into at least one of the first blocks, and the detecting step detects plural kinds of electronic watermarking data from at least one of second blocks in which the electronic watermarking data are inserted.

19. A recording medium readable by a computer, tangibly embodying a program of instructions executable by the computer to perform a method of inserting electronic watermarking data comprising the steps of:
inputting original image data divided into a plurality of blocks each of which includes pixels and converting the image data into a plurality of first frequency components for each block; and
inserting electronic watermarking data including special information into the first frequency components, wherein the inserting step inserts plural kinds of electronic watermarking data into at least one of the blocks.

20. A recording medium readable by a computer, tangibly embodying a program of instructions executable by the computer to perform a method of detecting electronic watermarking data comprising the steps of:
inputting image data which include inserted electronic watermarking data containing special information and are divided into a plurality of blocks each of which includes pixels, and converting the image data into a plurality of second frequency components for each block; and
detecting the inserted electronic watermarking data from the image data based on the second frequency components, wherein the detecting step detects plural kinds of electronic watermarking data from at least one of blocks in which the electronic watermarking data are inserted.

21. A recording medium readable by a computer, tangibly embodying a program of instructions executable by the computer to perform a method of inserting/detecting electronic watermarking data comprising the steps of:
inputting original image data divided into a plurality of first blocks each of which includes pixels and converting the image data into a plurality of first frequency components for each first block;
inserting electronic watermarking data including special information into the first frequency components;
inputting image data which include the inserted electronic watermarking data and are divided into a plurality of second blocks each of which includes pixels, and converting the image data into a plurality of second frequency components for each second block; and
detecting the inserted electronic watermarking data from the image data based on the second frequency components, wherein the inserting step inserts plural kinds of electronic watermarking data into at least one of the first blocks, and the detecting step detects plural kinds of electronic watermarking data from at least one of second blocks in which the electronic watermarking data are inserted.

22. A program product comprising, computer readable instructions and a recording medium bearing the computer readable instructions, the instructions being adaptable to enable a computer to perform a method of inserting electronic watermarking data comprising the steps of:
inputting original image data divided into a plurality of blocks each of which includes pixels and converting the image data into a plurality of first frequency components for each block; and
inserting electronic watermarking data including special information into the first frequency components, wherein the inserting step inserts plural kinds of electronic watermarking data into at least one of the blocks.

23. A program product comprising, computer readable instructions and a recording medium bearing the computer readable instructions, the instructions being adaptable to enable a computer to perform a method of detecting electronic watermarking data comprising the steps of:
inputting image data which include inserted electronic watermarking data containing special information and are divided into a plurality of blocks each of which includes pixels, and converting the image data into a plurality of second frequency components for each block; and
detecting the inserted electronic watermarking data from the image data based on the second frequency components, wherein the detecting step detects plural kinds of electronic watermarking data from at least one of blocks in which the electronic watermarking data are inserted.

24. A program product comprising, computer readable instructions and a recording medium bearing the computer readable instructions, the instructions being adaptable to enable a computer to perform a method of inserting/detecting electronic watermarking data comprising the steps of:
inputting original image data divided into a plurality of first blocks each of which includes pixels and converting the image data into a plurality of first frequency components for each first block;
inserting electronic watermarking data including special information into the first frequency components;
inputting image data which include the inserted electronic watermarking data and are divided into a plurality of second blocks each of which includes pixels, and converting the image data into a plurality of second frequency components for each second block; and
detecting the inserted electronic watermarking data from the image data based on the second frequency components, wherein the inserting step inserts plural kinds of electronic watermarking data into at least one of the first blocks, and the detecting step detects plural kinds of electronic watermarking data from at least one of second blocks in which the electronic watermarking data are inserted.
